(19) United States
(12) Patent Application Publication
(10) Pub. No.: US 2005/0017624 A1
(43) Pub. Date: Jan. 27, 2005

(54) Electron emitter with epitaxial layers

(76) Inventors: Thomas Novet, Corvallis, OR (US); Paul J. Benning, Lexington, MA (US); Alexander Govyadinov, Corvallis, OR (US); Robert Bicknell-Tassius, Springfield, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/626,171

(22) Filed: Jul. 23, 2003

(51) Int. Cl. H01J 1/38

(52) U.S. Cl. 313/311

(57) ABSTRACT

An emitter includes a single crystal electron source, an epitaxial layer, and a thin conductor layer. When an electric field is induced from the conductor across the epitaxial layer, electrons are emitted from the electron source, transported through the epitaxial layer, and are emitted from the conductor layer.

### FIELD OF THE INVENTION

The invention is in the microelectronics field. The invention particularly concerns emitters and devices incorporating emitters.

### BACKGROUND OF THE INVENTION

Emitters have a wide range of potential applicability in the microelectronics field. An emitter emits electrons in response to an electrical signal. The controlled emissions form a basis to create a range of useful electrical and optical effects. Prior conventional emitters include Spindt tip cold cathode devices as well as flat emitters. Challenges presented by Spindt tip emitters include their manufacturability and stability over their service life. Manufacturing of Spindt tip emitters is generally difficult and costly. Also, Spindt tip emitters require high vacuum for operation.

Traditional flat emitters are comparably advantageous because they present a larger emission surface that can be operated in less stringent vacuum environments. Flat emitters include a dielectric emission layer that responds to an electrical field created by a potential applied between an electron source and a thin metal layer on either side of a dielectric layer. Electrons travel from the electron source to the conduction band of the dielectric somewhere in the dielectric layer. Once into the conduction band, the electrons are accelerated towards the thin metal. The electrons then travel through the thin metal and exit the emitter.

Problems and unresolved needs remain with flat emitters, however. For example, emitted electron beams can suffer significant divergence. This can be disadvantageous in emitter applications in which the emitted electrons are to be directed to a defined target area. One significant source of electron beam divergence is electric field non-uniformities arising from non-planarity in the emitter surface and other electric defects to dielectric, conductor, and electron source layers.

Also, thickness irregularities and other layer inconsistencies may lead to layer regions that have a reduced resistance compared to other regions. These regions may experience a higher current flux than other layer regions, which may in turn increase the temperature of the region that further lowers resistance. The cycle of continually increasing temperature and continually reduced resistance may ultimately result in breakdown of the region. To reduce this risk, thicker dielectric layers may be used. Thicker layers, however, increase the required turn-on voltage of the emitter, lower emitter efficiency, and increase emission scatter.

These and other needs remain in the art.

### SUMMARY OF THE INVENTION

According to the invention, an emitter includes a single crystal electron source, a thin conductor layer, and an epitaxial layer between the conductor layer and the electron source.

### BRIEF DESCRIPTION OF THE DRAWINGS

FIG. 1 is a flowchart of a first embodiment method for making an emitter of the invention;

FIG. 2 is a schematic cross section of a first embodiment emitter device of the invention;

FIG. 3 is a flowchart of a second embodiment method for making an emitter of the invention;

FIG. 4 is a schematic cross section of a second embodiment emitter device of the invention;

FIG. 5 is a schematic of a first embodiment of an integrated circuit of the invention including an emitter of the invention;

FIG. 6 is a schematic of an exemplary embodiment of an emitter device of the invention including a target medium;

FIG. 7 is a schematic of an exemplary embodiment of a display device including emitters of the invention;

FIGS. 8A and 8B are schematics of an exemplary embodiment memory device including emitters of the invention; and,

FIG. 9 is a flowchart illustrating an exemplary embodiment of a method of emitting electrons of the invention.

### DETAILED DESCRIPTION OF THE INVENTION

The present invention is directed to emitter devices, methods for emitting electrons, and methods for making emitters. An exemplary emitter of the invention includes a single crystal electron source, a thin conductor layer, and an epitaxial dielectric layer between the conductor and the source layer. When an electric field is generated between the conductor layer and the electron source across the dielectric layer, electrons are emitted from the source. The electrons transport through the dielectric via tunneling or the like and are emitted from the surface of the conductor layer. The epitaxial dielectric layer and the conductor layers are substantially flat and free from geometrical and electrical defects. The electric field across the dielectric is therefore substantially uniform and unidirectional. As a result, electrons can be emitted substantially free of electrical field induced divergence.

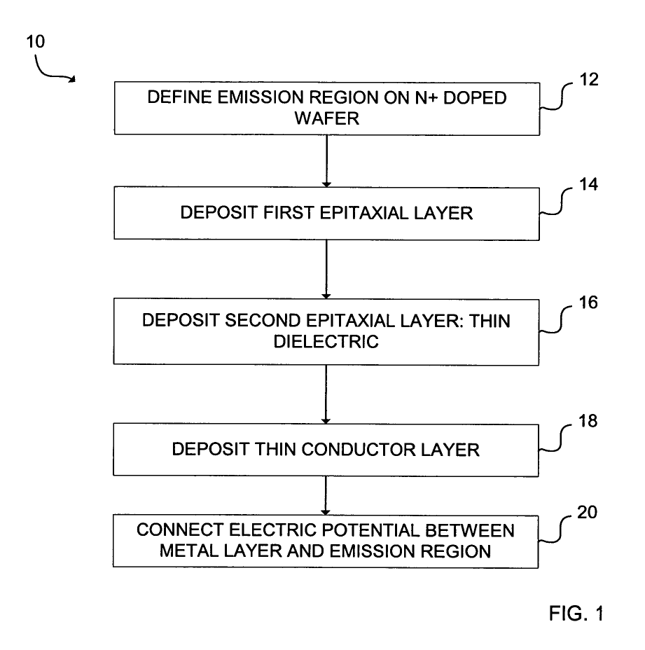

FIG. 1 is a flowchart illustrating a first method 10 for making an emitter of the invention. An emission region is defined on a single crystal N+ doped wafer electron source (block 12). A thin semi-conductor epitaxial layer is then formed on the electron source (block 14), and a thin-epitaxial dielectric layer is subsequently formed on the semi-conductor layer (block 16). A conductor layer is deposited on the semi-conductor layer (block 18), and the conductor and the emission source electrically linked (block 20). Preferably, the deposited conductor layer is epitaxial. In operation, the potential will induce an electric field between the conductor and the emission source sufficient to cause electrons to be emitted, to pass through the semi-conductor layer, to transport through the dielectric, and to be emitted from the conductor.

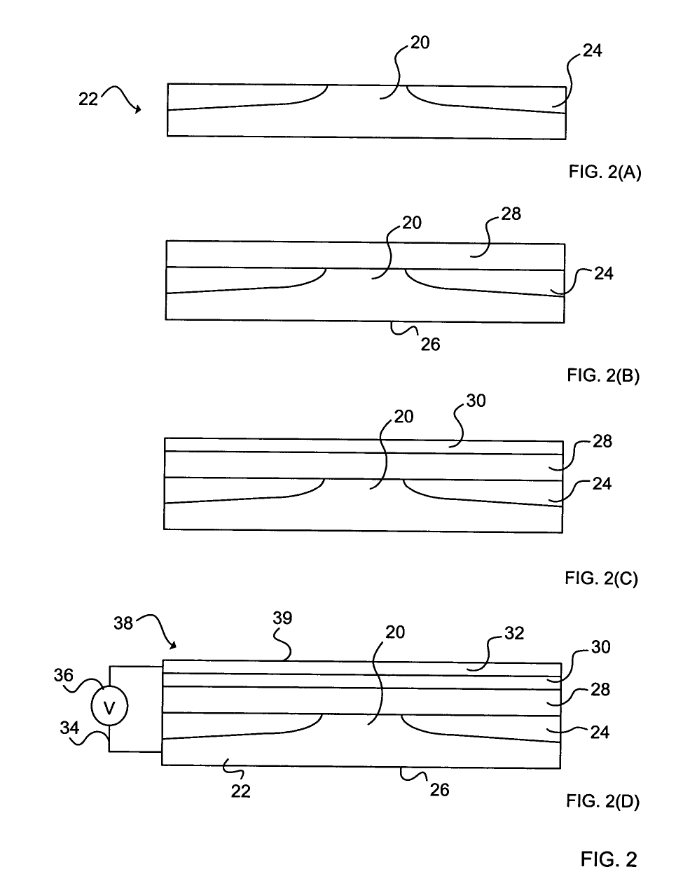

The exemplary method 10 may be further understood through the schematic cross section of FIG. 2 that shows stages of formation of an exemplary emitter of the invention. In FIG. 2A, an electron emission region 20 is defined in the N-doped Si layer 22 which may comprise, for instance, a Si wafer. The electron emission region 20 may be defined, for instance, by oxidizing a region 24 that surrounds it. The exemplary emission region 20 extends through the thickness of the layer 22, and widens with depth into the layer 22 so that substantially the entire bottom surface 26 of the layer 22 is part of the region 20. The electron emission region 20 when viewed from above may be substantially circular.

A thin epitaxial semi-conductor layer 28 is then formed on the layer 22, as shown by FIG. 2B. Preferably, the semi-conductor layer 28 is made of intrinsic Si and is less than about 20 microns thick. FIG. 2C illustrates a thin epitaxial dielectric layer 30 that is formed on the semi-conductor layer 28. The dielectric layer 30 may be made of any of a variety of suitable materials, with examples including, but not limited to, aluminum nitride or an oxide of silicon, aluminum, tantalum, titanium, hafnium, or zirconium. Super lattices of these materials are also contemplated. The exemplary layer 30 has a thickness of less than about 20 nm, and may be between about 1 and about 5 nm thick. The thickness of the layer 30 may be selected depending on the breakdown properties of the material making up the layer. For amorphous silicon oxide by way of example, the layer 30 may be about 15 nm thick. Single crystal materials are expected to withstand higher fields and are therefore useful to achieve thinner layers of between about 2 and about 10 nm. The layer 30 thickness may also be selected to provide enough electrical resistance to resist current flow at potentials of between about 10 and about 15 V, yet thin enough to minimize scattering as electrons transport through it or, such as by tunneling or the like.

An upper epitaxial electrode layer 32 is then formed on the dielectric layer 30. The exemplary electrode layer 32 will generally be made as thin as practical to minimize collision-based scattering of emitted electrons. By way of example, a thickness of less than about 7 nm may be used. Although the electrode layer 32 is preferably epitaxial, invention embodiments may be practiced using a non-epitaxial layer 32. The layer 32 should be as thin as practical to minimize scattering, yet should be thick enough to carry sufficient current to induce an electric field across the dielectric layer 28.

Exemplary materials of construction for the electrode layer 30 include metals such as Au and Pt when using a non-epitaxial layer, and N-doped semi-conductors such as phosphorous-doped Si when using an epitaxial layer. An electric connection 34 may be provided between the electrode layer 30 and the emission region 20. The epitaxial layers 28, 30, and 32 may be formed using methods generally known such as atomic layer deposition, high vacuum vaporizations and deposition, and the like. Atomic layer deposition is generally preferred because of its cost advantages over other methods.

A potential 36 is linked to the electric connection 34 to induce an electric field between the electrode layer 32 and the electron emission region 20. An exemplary emitter 38 results. In operation, the electric field induced by the potential 36 is sufficient to cause electrons to be emitted from the emission region 20, to be conducted across the semi-conductor layer 26, to transport through the dielectric layer 28, and to be emitted from the substantially flat surface 39 of the electrode 30.

Although the present invention is not bound by any particular theory, it is believed that because the wafer 22 is a single crystal layer, and the layers 28, 30 and 32 are epitaxial, electrons emitted from the emitter 38 are substantially free from divergence caused by spatial confinement of the quantum electron states. Surface irregularities produce spatial localization of the electrons before they are emitted. Due to quantum effects defined by the Heisenberg Uncertainty Principle, this spatial confinement gives rise to variation in the electron momentum directed parallel to the emitter surface. This additional momentum produces increased electron beam divergence, degrading the beam focus. For example, a surface irregularity that localizes an electron to a 50A emission feature will produce approximately 20 of divergence for electrons emitted with a few electron volts of energy. The same electrons emitted from a 2 um diameter single crystal will have less than about 0.1° of divergence added.

Because the wafer 22 is a single crystal layer, and the layers 28, 30 and 32 are epitaxial, electrons emitted from the emitter 38 are substantially free from divergence caused by geometrical based electrical field effects. For example, the interfacing surfaces between the layers 28, 30, and 32 are substantially free from irregularities such as bumps, valleys, and ridges. This reduces or eliminates divergent electrical fields that these irregularities would otherwise induce. As a result, emitted electrons may be free from divergence or subject only to divergence effects that result from thermal effects. Thermal-related divergence is believed to be limited to emission angles of less than about 10° from perpendicular. Also, the epitaxial layers 28, 30 and 32 are substantially free from electrical defects, and are highly uniform in thickness. This further promotes substantially uniform and uni-directional electrical fields across each of the layers 28 and 30.

The epitaxial semi-conductor layer 28 has been provided in the exemplary emitter of FIG. 2 to provide various benefits and advantages. For example, it can function as a distributed ballast resistor to ensure a highly uniform electric field acting on the emission region 20. This layer 28 also protects the emitter from electrical breakdown of the dielectric layer 30. Very thin dielectric layers 30 may therefore be used in emitters of the invention with risks associated with their breakdown minimized.

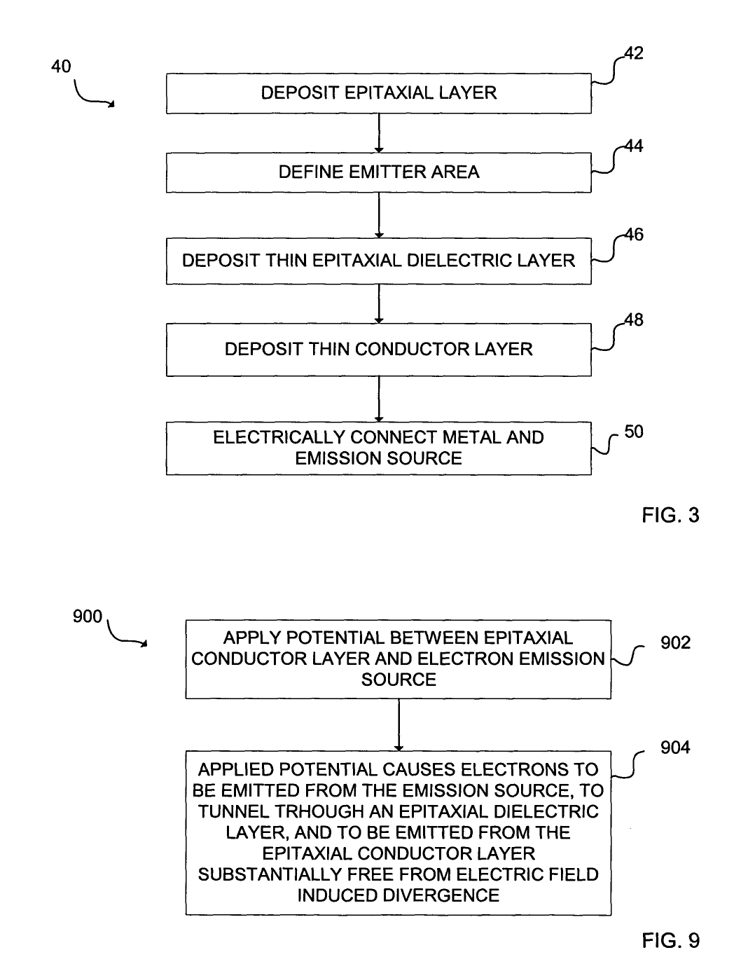

Other invention embodiments include emitters and methods for making emitters without a semi-conductor layer such as the layer 28. These methods and emitters may be advantageous depending on design and application particulars. The flowchart of FIG. 3, for instance, illustrates a second exemplary method 40 of the invention. Practice of the method 40 results in an emitter that does not include a semi-conductor layer. An initial step of the method 40 includes depositing an epitaxial layer (block 42). The epitaxial layer may be formed on a single crystal substrate or other support, with an N-doped Si wafer as an example. An electron emission region is then defined in the epitaxial layer (block 44). A thin dielectric epitaxial layer is next formed on the first layer (block 46). Finally, an epitaxial conductor such as a thin conductor is then formed on the dielectric (block 48), and an electrical potential is connected between the emission region and the conductor layer (block 50).

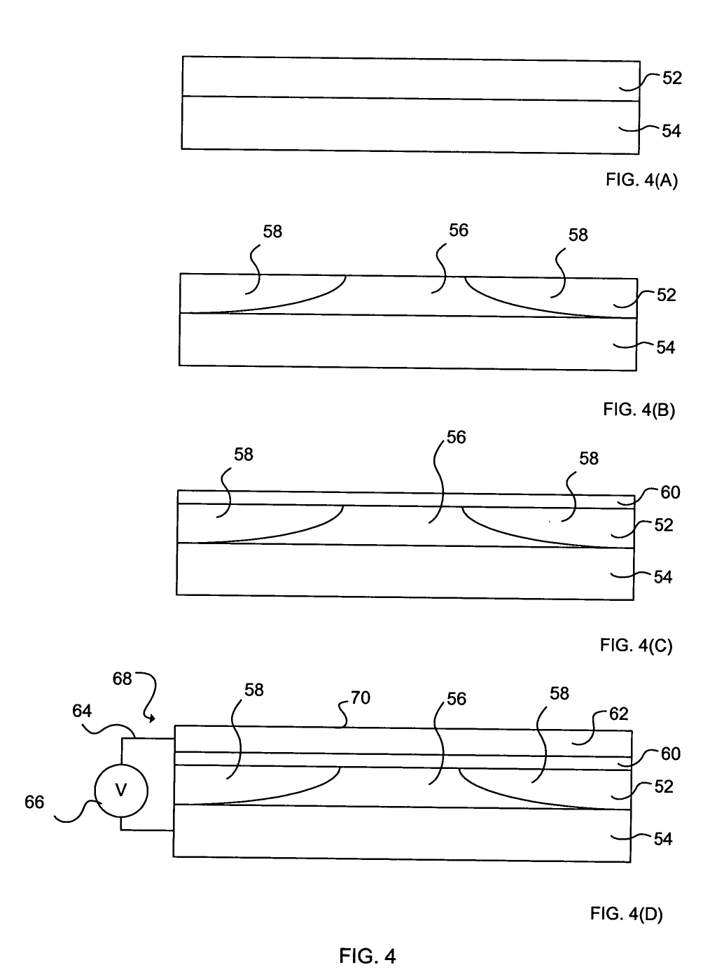

The exemplary method 40 of FIG. 3 may be further understood through consideration of the schematic cross section of FIG. 4 illustrating exemplary stages of emitter formation. In FIG. 4A, an epitaxial layer 52 is formed on a support 54. The epitaxial layer 52 may be formed using methods generally known such as atomic layer deposition, molecular beam epitaxy, chemical vapor deposition, and the like. An exemplary layer 52 is made of intrinsic Si, while an exemplary support 54 may be an N-doped single crystal Si wafer. The thickness of the layer 52 may vary depending on design considerations, but by way of example a thickness of between about 5 and about 20 microns may prove useful in may applications. For intrinsic silicon, for example, a thickness of between about 5 and about 20 micron would be useful for many applications.

FIG. 4B illustrates an electron source emission region 56 defined in the epitaxial layer 52. The emission region 56 may be defined through oxidation of an adjacent perimeter region 58 that substantially surrounds a perimeter of the emission region 56, or by other means. As illustrated, the exemplary emission region 56 is continuous across the thickness of the layer 52 to extend to the wafer 54. Also, the exemplary region 56 widens through the thickness of the layer 52, so that the emission region 56 covers at least a large portion of the interface between the layers 52 and 54. The wafer 54 may therefore supply electrons to the emission region 56.

FIG. 4C shows a thin epitaxial dielectric layer 60 that has been formed on the layer 52. The exemplary dielectric layer 60 is less than about 20 nm thick, and may be between about 1 and about 5 nm. The thickness may be specified, for example, to be great enough to hold off between about 10 and about 15 V, yet thin enough to minimize scattering as electrons transport through it. The tunneling resistance of the dielectric layer 60 may be of the order of the electrical resistance of the epitaxial layer 52. For an intrinsic silicon epitaxial layer with thickness of between about 5 and about 20 micron, for example, a dielectric layer having a thickness of between about 2 and about 10 nm would be useful. Exemplary materials for making the layer 60 include, but are not limited to, aluminum nitride or an oxide of silicon, aluminum, tantalum, titanium, hafnium, or zirconium. Super lattices of these materials are also contemplated. The layer 60 may be formed through known epitaxial formation methods, with atomic layer deposition being a generally cost effective exemplary method.

The next step of emitter formation is illustrated by FIG. 4D with a thin conductor layer 62 having been formed on the dielectric layer 60. Preferably, the layer 62 is epitaxial. The exemplary thin conductor layer 62 is less than about 7 nm thick, and may be made as thin as practical to minimize collision-based scattering of emitted electrons. The electrode layer 62 may be made of a metal such as Au or Pt as well as semi-conductors such as N-doped phosphorous-doped silicon. Like the layers 52 and 60, the layer 62 may be formed through known epitaxial formation methods including the generally cost effective method of atomic layer deposition. An electrical connection 64 is provided between the electrode layer 62 and the wafer 54 and linked to a potential 66. The exemplary emitter 68 results.

The potential 66 is sufficient to induce electrons to be emitted from the emission region 56, to transport through the dielectric layer 60 through tunneling or the like, and to be emitted from the surface 70 of the thin conductor layer 62. It will be appreciated that many of the benefits and advantages of the emitter 38 of FIG. 2 apply as well to the emitter 68 of FIG. 4. For example, the epitaxial layers 52, 60, and 62 promote a substantially uniform and uni-directional electric field with the result that electrons emitted from the conductor layer surface 66 are substantially free from electric field induced divergence.

As noted above, the exemplary emitter 68 differs from the emitter 38 of FIG. 2 in that no epitaxial semi-conductor layer has been provided. Instead, the epitaxial dielectric layer 60 is formed directly over the emission region 56. The emitter 68 also differs from the emitter 38 in that the emission area 56 is defined in a formed epitaxial layer 52 instead of in the underlying wafer 54. These aspects of the emitter 68 may be advantageous due to the possible occurrence of defects in the emitter 38 of FIG. 2's epitaxial semi-conductor layer 28 near the boundary of the emission region 20. In particular, it is believed that forming an epitaxial semi-conductor layer 28 over the partially oxidized wafer 22 in some circumstances has the potential of causing defects in the layer 28 above the perimeter of the emission region 20. This potential is greatly reduced in the emitter 68 of FIG. 4 where the emission region 56 has been defined in the epitaxial layer 52.

Flat emitters such as those generally illustrated at 38 and 68 achieve many advantages and benefits. For example, it is believed that due to the substantially flat and thin epitaxial layers used in emitters of the invention, divergence of emitted electrons is minimized. Less scattering is experienced due to the uniform electric field across the substantially flat and thin epitaxial dielectric layer, as well as the elimination geometrical irregularities at layer interfaces. It is believed that emitters of the invention such as the emitters 38 and 68 are operative to emit electrons with a divergence angle that is substantially only thermally affected, and that may be between about 5° and about 100 from perpendicular to the emission surface. This allows for tighter concentration and focusing of emissions. Another exemplary benefit of emitters of the invention may be found in their relatively high emission efficiency. Because the substantially uniform epitaxial dielectric layer allows for a very thin layer to be used, it is believed that exemplary flat emitters of the invention achieve emission efficiencies of greater than about 6%. Efficiencies as high as about 10% or greater are believed to be achievable.

These and other advantages of emitters of the invention and of methods of emitting electrons of the invention lend themselves well to a wide-range of potential uses, including several electrical, electrochemical, and electro-optical effects. Further, emitters of the invention are easily incorporated into integrated circuit fabrication techniques. A few particularly preferred applications of emitters and methods of emitting electrons of the invention will now be discussed by way of example.

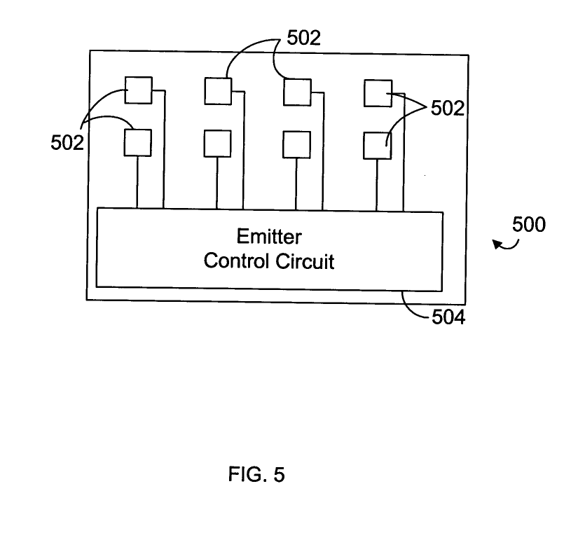

FIG. 5, for example, is a schematic of an exemplary integrated circuit embodiment 500 of the invention that includes at least one and preferably a plurality of integrated emitters 502 arranged in an array or other selected manner. An emitter control circuit 504 is integrated onto the integrated circuit 500 and used to operate the integrated emitters 502.

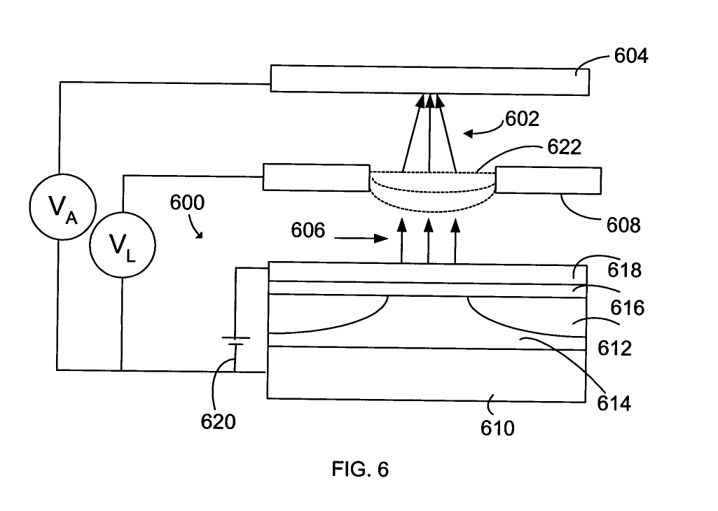

FIG. 6 is a schematic of an exemplary emitter device of the invention including an emitter shown generally at 600 useful to generate focused electrons 602 to impact a target 604. In the application of FIG. 6, the emitted electrons generally indicated by the arrows 606 from the emitter 600 of the invention are focused by an electrostatic focusing device or lens 608. The emitter 600 generally comprises a single crystal Si wafer 610, an epitaxial layer 612 that includes an emission region 614, an epitaxial dielectric layer 616, and an epitaxial conductor layer 618.

When a sufficient potential is applied across an electrical connection 620, an electric field is induced across the dielectric layer 616. The field has sufficient strength to cause electrons to be emitted from the emission region 614, to transport through the epitaxial dielectric layer 616 via tunneling or the like, and to be emitted from the dielectric conductor layer 618 as indicated by the arrows 606.

Within the lens 608, a conductor with an aperture 622 can be set at a predetermined voltage V_{L} that can be adjusted to change the focusing effect of the lens 608. Those skilled in the art will appreciate that the lens 608 can be made from more than one conductor layer to create a desired focusing effect. The emissions 606 are focused by the lens 608 into a focused beam 602 directed onto the target anode medium 604. The target anode medium 604 is set at an anode voltage V_{A}. The magnitude of V_{A} will depend on factors such as the intended emitter use, the distance between the target 604 and the emitter 600, and the like.

For example, with the anode medium 604 being a recordable memory medium for a storage device, V_{A} might be chosen to be between about 600 and about 2000 volts. The lens 608 focuses the electron emissions 606 by forming an electric field in the aperture 622 in response to the voltage V_{L}. By being set at a proper voltage difference from the potential across the connection 620, the emitted electrons 606 from the emitter 600 are directed to the center of the aperture 622 and then further attracted to the target anode medium 604 to form the focused beam 602.

The target 604 may be configured as appropriate for any of several emitter applications with two preferred applications including the target 604 being a visual display or a memory. If the target anode medium 604 comprises a display, the focusing of the beam onto the target 604 can be used to produce an effect to stimulate a visual display. Similarly, if the target anode medium 604 is a memory, the electrochemical properties of the target 604 may be changed through the focused beam 602. These changes may be “coded” in a binary or other manner to store retrievable information, for instance by spatially organizing portions of the target anode medium 604 and then selectively changing some of those portions through the emitted electrons 602. A visual display medium and a memory medium of the invention may employ a plurality of spatially arranged emitters 600, and may employ a mover such as a micro-positioner driven by a motor for moving one of the emitter 600 or the target anode medium 604 relative to the other. Also, a control circuit may be used to control the emitters 600 and/or other components.

Some advantages of emitters of the invention, such as the emitter 600, may be appreciated through consideration of the application of FIG. 6. For example, it will be appreciated that emitters of the invention may be used to achieve highly compact emitter applications. The individual layers of emitters of the invention may be thinner than those of the prior art due to their epitaxial nature. Also, the relatively low divergence of emitted electrons of emitters of the invention eliminates the need for dielectric wells on the emitter surface in some applications. This reduces the overall size of emitters of the invention and also achieves cost savings.

Further, in some applications the low divergence of emitters of the invention will allow focusing to a much smaller spot by the lens 608 on the target 604. These smaller focus spots allow for a high storage density to be achieved. It is believed that a memory density of about a terabit per in² can be achieved using a memory device of the present invention.

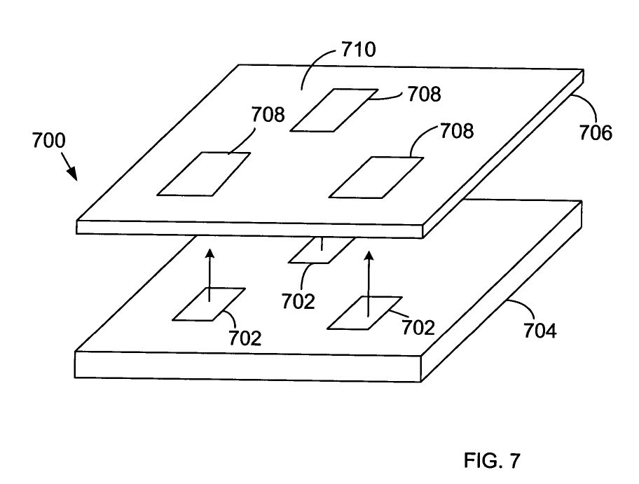

FIG. 7 is a schematic embodiment of a display application using a plurality of epitaxial layer flat emitters 702 formed and spatially arranged in an integrated circuit 704. Each of the emitters 702 emits electrons, as generally illustrated by the upwardly directed arrows of FIG. 7. An anode structure 706 having a plurality of individual pixels 708 that form a display 710 receives the emitted electrons. The pixels 708 may be, for example, a phosphor material that creates photons when struck by emissions from the emitters 702. Other components such as a power supply, a control circuit, and the like may also be provided. Because of the low divergence of emitted electrons of the invention, the emitted electrons will be tightly clustered and directed. This embodiment of the invention may thereby be practiced without the use of focusing means, although practice with focusing means is also contemplated. This aspect of the invention may be beneficial, for example, to minimize the required size of the pixels 708, or to achieve enhanced brightness and clarity of resultant displays.

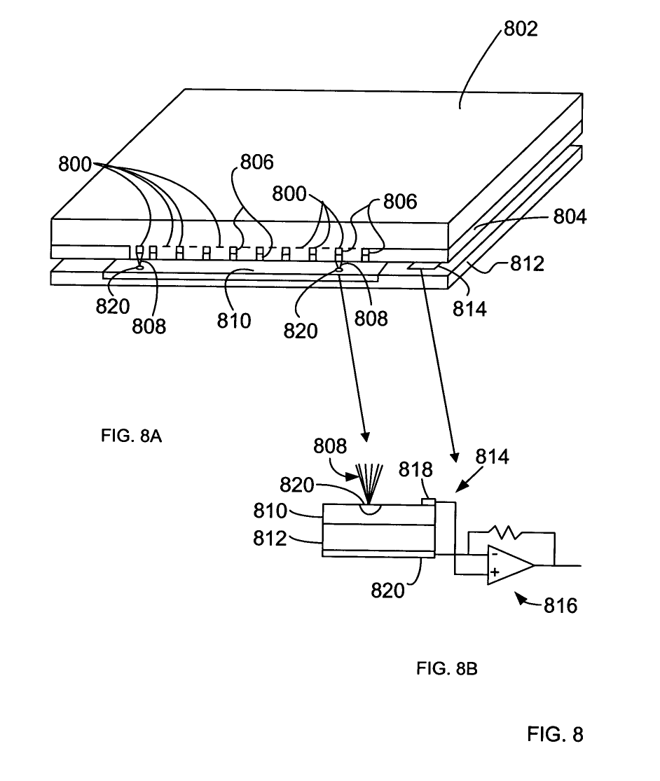

A particular preferred memory device of the invention is schematically illustrated in FIGS. 8A and 8B. The emitters 800 may be generally consistent with either of the emitters 38 or 68 of FIGS. 2 and 4, respectively. The memory device includes a plurality of flat emitters 800 of the invention that may include a single crystal wafer, an epitaxial layer including an emission area, an epitaxial dielectric layer, and a thin epitaxial conductor layer. In the exemplary embodiment of FIG. 8, the plurality of emitters 800 are integrated into an integrated circuit (IC) 802. A lens array 804 of focusing mechanisms 806 that may be aligned with the integrated emitters 800 is used to create one or more focused beams 808 of electrons that may be directed onto selected regions of a recording surface media 810. Memory devices that do not require the lens array 804 are also contemplated. The surface media 810 is linked to a mover 812 that positions the media 810 with respect to the integrated emitters 800 and/or the lens array 804. Preferably, the mover 812 has a reader circuit 814 integrated within.

The reader circuit 814 is illustrated in greater detail in FIG. 8B as an amplifier 816 making a first ohmic contact 818 to the media 810 and a second ohmic contact 820 to the mover 812, preferably a semiconductor or conductor substrate. When a focused beam 808 impacts the media 810 through striking it or other contact, if the current density of the focused beam is high enough, a portion of the media 810 is phase-changed to create an affected media area 820. When a low current density focused beam 806 is applied to the media 810 surface, different rates of current flow are detected by the amplifier 816 to create reader output. Thus, by affecting the media 810 with the energy from the emitter 800, information is stored in the media using structural phase changed properties of the media. An exemplary phase-change material is InSe.

Still an additional embodiment of the present invention is directed to a method for emitting electrons. FIG. 9 is a flowchart illustrating an exemplary method 900 for emitting electrons. A potential is applied between an epitaxial conductor layer and an electron emission area in a single crystal electron source (block 902). The electric field is sufficient to cause electrons to be emitted from the electron emission source, to tunnel or otherwise transport through an epitaxial dielectric layer, and to be emitted from the epitaxial conductor layer (block 904). An epitaxial semi-conductor layer may also be tunneled or transported through. The electrons are emitted from the epitaxial conductor layer substantially free from electric field induced divergence. It will be appreciated that additional details regarding this and other exemplary embodiments of emitting electrons of the invention have been illustrated herein through discussion of exemplary emitters of the invention.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. For example, it will be appreciated that many applications in addition to a memory and a visual display may be practiced using an emitter of the invention.

Various features of the invention are set forth in the appended claims.

1. A method for making a flat emitter comprising the steps of:
defining an emission region in a single crystal electron source;
forming at least a first epitaxial layer on said single crystal electron source; and
forming a thin conductor layer on said at least one epitaxial layer.

2. A method for making a flat emitter as defined by claim 1 wherein the steps of forming said at least a first epitaxial layer comprises forming said layer through atomic layer deposition.

3. A method for making a flat emitter as defined by claim 1 wherein the step of defining an emission region in said single crystal electron source comprises oxidizing a region proximate to said emission region.

4. A method for making a flat emitter as defined by claim 1 and further including the step of forming said single crystal electron source layer on an underlying single crystal electron source layer.

5. A method for making a flat emitter as defined by claim 1 wherein said at least a first epitaxial layer comprises a dielectric layer.

6. A method for making a flat emitter as defined by claim 1 wherein the step of forming said at least a first epitaxial layer comprises forming an epitaxial semi-conductor layer on said single crystal electron source and forming an epitaxial dielectric layer overlying said epitaxial semi-conductor layer.

7. A method for making a flat emitter as defined by claim 6 wherein said epitaxial dielectric layer is between about 1-5 nm thick, and wherein said epitaxial semiconductor layer is less than about 20 microns thick.

8. A method for making a flat emitter as defined by claim 1 wherein said thin conductor layer is an epitaxial conductor layer.

9. A method for making a flat emitter as defined by claim 8 wherein said epitaxial conductor layer is an N-doped semiconductor.

10. An electron emitter device comprising:
a single crystal electron source including an emission region;
a thin conductor layer; and
an epitaxial dielectric layer between said single crystal electron source and said thin conductor layer.

11. An emitter device as defined by claim 10 wherein said emitter is operative to emit electrons substantially free from electric field induced divergence.

12. An emitter device as defined by claim 10 wherein electrons are emitted from said thin conductor layer at a divergence of less than about 10° from perpendicular.

13. An emitter device as defined by claim 10 wherein said thin conductor layer is epitaxial.

14. An emitter device as defined by claim 10 wherein the emitter is operative to generate an electric field across said epitaxial dielectric layer to cause electrons to be emitted from said electron source emission region, to transport through said epitaxial dielectric layer, and to be emitted from said epitaxial conductor layer substantially free from electrical field induced divergence.

15. An emitter device as defined by claim 10 wherein said epitaxial dielectric layer is configured to promote a substantially uniform and uni-directional electric field across its thickness.

16. An emitter device as defined by claim 10 wherein said single crystal electron source comprises an epitaxial layer formed on a single crystal support.

17. An emitter device as defined by claim 16 wherein said emission region extends through the thickness of said epitaxial electron source layer to contact said single crystal support.

18. An emitter device as defined by claim 10 wherein said emission region has a perimeter substantially surrounded by a dielectric.

19. An emitter device as defined by claim 10 wherein the device is at least about 6% efficient.

20. An emitter device as defined by claim 10 wherein the device is at least about 10% efficient.

21. An emitter device as defined by claim 10 wherein said conductor layer has a substantially flat surface defining an emission surface of the emitter

22. An emitter device as defined by claim 10 wherein said epitaxial dielectric layer has a thickness of less than about 20 nm.

23. An emitter device as defined by claim 10 wherein said epitaxial dielectric layer has a thickness between about 2 and about 10 nm.

24. An emitter device as defined by claim 10 wherein said epitaxial dielectric layer is made of one of aluminum nitride or an oxide of silicon, aluminum, tantalum, titanium, hafnium, or zirconium.

25. An emitter device as defined by claim 10 and further including an epitaxial semi-conductor layer sandwiched between said electron source and said epitaxial dielectric layer.

26. An emitter device as defined by claim 28 wherein said epitaxial semi-conductor layer is less than about 20 microns thick.

27. An emitter device as defined by claim 26 wherein said epitaxial semi-conductor layer is between about 1 and about 5 microns thick.

28. An emitter device as defined by claim 10 wherein said conductor layer is less than about 7 nm thick.

29. An emitter device as defined by claim 10 and further including an electrical connection between said single crystal electron source and said thin epitaxial conductor layer, said connection linked to a potential sufficient to induce an electric field between said conductor layer and said electron source layer to cause electrons to be emitted from said electron source, to transport through said epitaxial layer, and to be emitted from said conductor layer substantially free from electrical field related divergence.

30. An emitter device as defined by claim 10 and further including a target, said conducting layer configured to direct said emitted electrons towards said target and to cause an effect on said target upon impact.

31. An emitter device as defined by claim 30 and further including focusing means positioned between said target and the emitter.

32. An emitter device as defined by claim 31 wherein said focusing means comprises an electrostatic focusing lens having an aperture in a conductor set at a predetermined voltage, said voltage adjustable to change the focusing effect of said focusing lens.

33. An emitter device as defined by claim 30 wherein said target comprises a memory, and wherein said effect comprises a physical change to said target, said physical change detectable through measurement of electrical properties of said memory.

34. An emitter device as defined by claim 33 wherein said emitter is operable to achieve a density of said physical changes of about a terabit per in² on said memory.

35. An emitter device as defined by claim 30 wherein said target comprises a display having a plurality of pixels, and wherein said effect comprises a visual change in one of said pixels when said emitted electrons are received by said one of said pixels.

36. An emitter device as defined by claim 30 and further including a mover connected to one or more of the emitter or said target for moving said one or more of the emitter or said target.

37. An integrated circuit including a plurality of the emitter devices as defined by claim 10 and further including control circuitry connected to said plurality of emitter devices.

38. An emitter memory device including a plurality of the emitter devices as defined by claim 10 arranged in an array, further including a memory, and further including a plurality of focusing lens arranged to cooperate with said array of emitter devices, each of said focusing lens configured to focus electrons emitted from one of said emitter devices and to direct said focused electrons towards said memory, said focused electrons causing a structural phase change in said memory upon impact, said structural phase changes having a density of about a terabit per in² on said memory, and an integrated reader circuit for detecting said structural phase change through measurement of electrical properties.

39. A method for emitting electrons from an emitter comprising the steps of:
generating an electric field across an epitaxial dielectric layer from a thin conductor layer, said electric field substantially uniform and free from geometrical based divergence, said electric field operative to cause electrons to be emitted from said electron source, to transport through said epitaxial dielectric layer, and to be emitted from said thin dielectric conductor layer.

40. A method for emitting electrons as defined by claim 39 and further including the step of causing said electrons to transport through an epitaxial semi-conductor layer positioned between said electron source and said epitaxial dielectric layer.

41. A method for emitting electrons as defined by claim 39 wherein said electrons are emitted at an angle of less than about 10° from perpendicular from said conductor layer.

42. A method for emitting electrons as defined by claim 39 wherein the method further includes the step of directing said emitted electrons at an anode target, and of causing an effect in said target when said emitted electrons strike said target, said target comprising one of a memory or a display, and said effect being detectable through measurement of an electrical property.

43. A method for emitting electrons as defined by claim 39 wherein said electrons are emitted at an efficiency of at least about 6%.
